(19) United States
(12) Patent Application Publication
(10) Pub. No.: US 2011/0202716 A1
(43) Pub. Date: Aug. 18, 2011

(54) STORAGE SYSTEM AND DATA WRITING METHOD

(75) Inventor: Reisuke NAKAGAWA, Kawasaki (JP)

(73) Assignee: FUJITSU LIMITED, Kawasaki-shi (JP)

(21) Appl. No.: 13/011,290

(22) Filed: Jan. 21, 2011

(30) Foreign Application Priority Data
Feb. 16, 2010 (JP) 2010-031570

(51) Int. Cl. G06F 12/08

(52) U.S. Cl. 711/113; 711/E12.019

(57) ABSTRACT

A storage system includes: storage devices storing data and varying in data-writing speed; a cash memory storing the write data until the write data is written to the storage device; a storage section that stores the write data received from an external device in the cash memory; and a writing section that takes the write data from the cash memory and writes the taken write data to the storage device. The storage section stores the write data received from the external device, in a storage area according to the type of the storage device to which the write data is to be written, among storage areas resulting from division according to the types of the storage devices. The writing section sequentially takes the write data from the storage area sequentially selected from among the storage areas on the cash memory and writes the taken data to the storage device.

### CROSS-REFERENCE TO RELATED APPLICATION

This application is based upon and claims the benefit of priority of the prior Japanese Patent Application No. 2010-031570, filed on Feb. 16, 2010, the entire contents of which are incorporated herein by reference.

### FIELD

The embodiment discussed herein is related to a storage system that houses plural storage devices such as a Hard Disk Drive (HDD), and a method of writing data to the storage devices in the storage system.

### BACKGROUND

There is known a storage system in which plural storage devices are housed, such as a RAID apparatus. This RAID apparatus has a cache memory that temporarily stores write data received from an external device such as a host. Upon receipt of the write data from the external device, the RAID apparatus stores the received write data in the cache memory temporarily, takes out the write data from the cache memory according to a mode such as FIFO (First In First Out) and LRU (Least Recently Used), and stores the taken data into a storage device.

In recent years, various types of storage device such as HDD (Hard Disk Drive), SATA (Serial Advanced Technology Attachment) and SSD (Solid State Drive) have appeared, and there has been a case in which these various types of storage device are mixedly housed in the RAID apparatus. Incidentally, SATA is an interface type name, and here, a HDD having a connecting interface of SATA is referred to as SATA.

These storage devices vary in data-writing speed by type. For example, the SSD has the highest data-writing speed, followed by the HDD, and the SATA has the lowest writing speed.

When a large amount of write data is sent from the external device to the RAID apparatus, the cache memory tends to be congested with the write data to be written to the storage device of the low-writing-speed type. For this reason, even when the cache memory overflows with the data to be written to the storage device of the low-writing-speed type and in this state, data to be written to the SSD of the high-writing-speed type arrives, the data to be written to the SSD is forced to keep waiting for a long time since the writing to the SSD does not begin promptly. As a result, there is a case in which the original high-speed writing property of the SSD does not come into play, and there occurs a degradation (so-called “sinking”) in the performance of the SSD.

Conventionally, in order to increase the input-output response time for the storage devices varying in performance, assigning a partial area of the cache memory according to the response time of the storage device has been proposed.

However, suppose the area of the cache memory is divided into plural domains according the response time of the storage devices, in what order plural pieces of write data stored in these plural domains are taken and written to disks becomes a problem. When the writing to the storage device having the short response time and capable of high-speed access is given a high priority, the writing to the storage device having the long response time and accessing at a low speed may become extremely late as a result.

Further, besides this proposal, there are other suggestions including: a proposal in which both the HDD and a semiconductor disk are provided and the same pieces of data are written to both of the HDD and the semiconductor disk, and in response to a read-out command, when data corresponding to the read-out command is in the semiconductor disk, the data is read from the semiconductor disk and thereby a higher speed is achieved; and a proposal in which a system degradation at the time when a failure occurs in the HDD is suppressed.

For reference, see Japanese Laid-open Patent Publications No. 2002-140169, No. 10-40170 and No. 2001-43027, for example.

### SUMMARY

A storage system according to an aspect of the invention is related a system which is connected to an external device.

The storage system includes a cash memory, a storage section and a writing section.

The cash memory stores the write data to be written to the individual storage device, until the write data is written to the individual storage device.

The storage section stores the write data received from the external device and to be written to the individual storage device, in a storage area according to a type of the individual storage device to which the write data is to be written, among plural storage areas divided according to respective types of the individual storage devices, of the cash memory.

The writing section sequentially takes the write data from the storage area sequentially selected from among the plural storage areas in the cash memory and writes the taken data to the individual storage device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram of a RAID apparatus serving as an embodiment of the storage system of the present application;

FIG. 2 is a block diagram of the controller of the RAID apparatus illustrated in FIG. 1;

FIG. 3 is a conceptual diagram of the flow-rate management table;

FIG. 4 is a diagram that illustrates the cache memory and the flag storage section;

FIG. 5 is a diagram that illustrates a list of pieces of write data newly transmitted from the host;

FIG. 6 is a diagram that illustrates the cache memory in a state in which the write data illustrated in FIG. 5 is stored in the cache memory illustrated in FIG. 4;

FIG. 7 is a flow chart that illustrates the processing of the storage section that follows the above-described rule;

FIG. 8 is a flow chart that illustrates the processing of the writing section;

FIG. 9 illustrates a data flow between the cache memory and each enclosure; and

FIG. 10 is a diagram that illustrates the order of taking the write data from the cache memory in the state illustrated in FIG. 6.

### DESCRIPTION OF EMBODIMENTS

An embodiment of the present application will be described below.

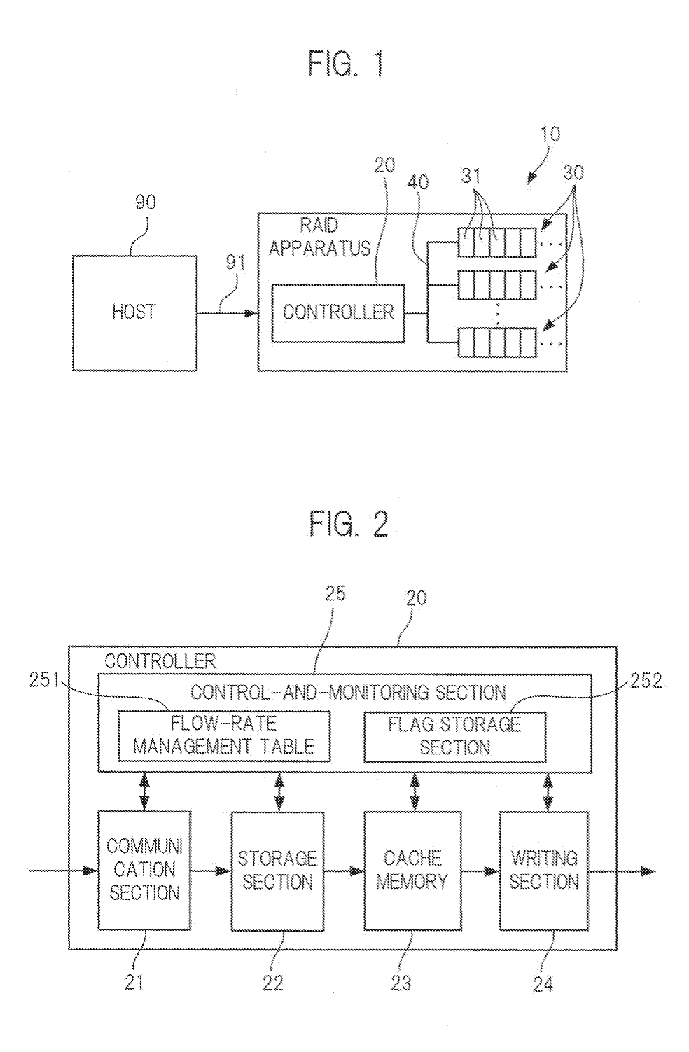

FIG. 1 is a schematic diagram of a RAID apparatus serving as an embodiment of the storage system of the present application.

This RAID apparatus 10 has a controller 20 and plural enclosures 30. Each of the enclosures 30 is shaped like a shelf, and loaded with storage devices (referred to as disks 31, here). In each of the enclosures 30, plural connectors connected to the disks 31 which are loaded into that enclosure 30 are aligned. Further, in each of the enclosures 30, a control circuit to control the disks 31 loaded into that enclosure 30 is disposed. Into each of the enclosures 30, the plural disks 31 may be loaded by connecting the plural disks 31 to the respective plural connectors aligned in that enclosure 30.

Here, in each of the enclosures 30, the plural disks 31 are aligned in a state of being respectively connected to the connectors. The controller 20 and each of the enclosures 30 are connected to each other by wiring 40. This wiring 40 supports communications between the disks 31 connected to the connectors of the enclosure 30 and the controller 20. However, this wiring 40 is restricted in terms of an upper limit of capacity in communication for each of the enclosures 30.

This RAID apparatus 10 is connected to a host 90 that is an external device, with a communication line 91. The controller 20 of this RAID apparatus receives write data to be written to the disk 31 from the host 90 and writes the received data to the disk 31. Also, in response to a command from the host 90, the controller 20 of the RAID apparatus reads data from the disk 31 and sends the read data to the host 90.

In this RAID apparatus 10, plural types of disk 31 varying in data-writing speed are housed. Specifically, the RAID apparatus 100 of the present embodiment houses three types of disk including SSD, HDD and SATA. Incidentally, the SATA is one mode of the HDD, but has a different access speed, and thus will be described here as being of the type different from the type of an ordinary HDD (for example, an HDD with SAS connection and an HDD with FC connection). Among these three types of disk 31, the SSD has the highest data-writing speed, and the SATA is the lowest data-writing speed.

FIG. 2 is a block diagram of the controller of the RAID apparatus illustrated in FIG. 1.

This controller 20 includes a communication section 21, a storage section 22, a cache memory 23, a writing section 24 and a control-and-monitoring section 25.

The cache memory 23 is a memory that stores the write data, which is received from the host 90 and to be written to the disk 31 (see FIG. 1), until the data is written to the disk 31. This cache memory 23 has storage areas resulting from division according to each type of the disk 31 to which the write data to be written.

The communication section 21 carries out communication with the host 90.

The storage section 22 stores the write data to be written to the disk 31 (see FIG. 1), which is received by the communication section 21, in the cache memory 23. This storage section 22 stores the write data to be written to the disk 31, which is received by the communication section 21, in the storage area, among the storage areas resulting from the division according to the types of the disks 31 of the cache memory 23, corresponding to the type of the disk 31 to which this write data is to be written.

The writing section 24 takes out the write data from the cache memory 23, and writes the data to the disk 31. When taking the write data from the cache memory 23, this writing section 24 sequentially takes out the write data from those selected from among the storage areas in the cache memory 23 and varying cyclically, and then, the writing section 24 writes the taken data to the disk 31.

The control-and-monitoring section 25 performs monitoring and the like of the entire control of the controller 20 and flow of data. This control-and-monitoring section 25 has information about an ID of each of the disks 31 and the type of each of the disks 31 housed in each of the enclosures 30. This control-and-monitoring section 25 recognizes the disk 31 to which the write data received by the communication section 21 is to be written, and gives an instruction indicating a storage destination or a writing destination to the storage section 22 or the writing section 24, respectively. Further, this control-and-monitoring section 25 constantly monitors a flow rate of data for each of the disks 31. The control-and-monitoring section 25 updates a flow-rate management table 251 that indicates the flow rate for each of the disks 31.

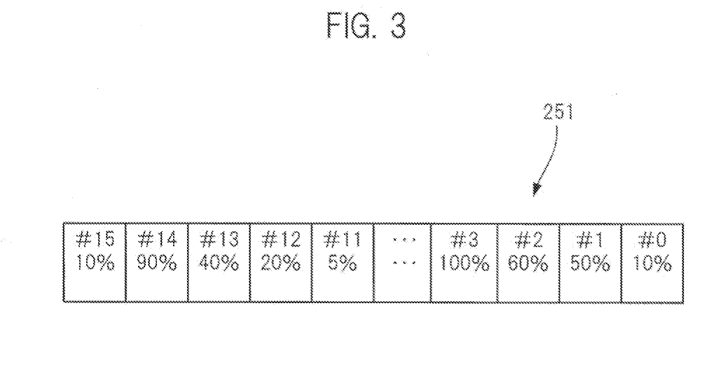

FIG. 3 is a conceptual diagram of the flow-rate management table.

Here, sixteen disks #0 to #15 are aligned in one enclosure 30 and, the flow rates of the respective disks #0 to #15 are recorded as 10%, 50%, 60%, 100%, . . . and 10%. Here, “100%” of the disk #3 indicates the disk #3 being in a busy state in which start of a new access to the disk #3 is disabled. This flow-rate management table is created for each of the enclosures 30, and is updated regularly to reflect the result of monitoring the flow rate changing momentarily by the control-and-monitoring section 25. This flow-rate management table 251 is equivalent to an example of the state management table in the present application, and the control-and-monitoring section 25 is equivalent to an example of the update section in the present application.

Returning to FIG. 2, the description will be continued.

Further, the control-and-monitoring section 25 includes a flag storage section 252 that stores a flag corresponding to each of the plural storage areas of the cache memory 23, and the flag represents whether the write data is stored in the corresponding storage area. Here, this flag is referred to as an empty flag. Specifically, flag-on represents an empty state in which no write data is stored in the storage area, while flag-off represents the write data being stored in the storage area.

Next, the operation of the storage section 22 and the writing section 24 will be described specifically.

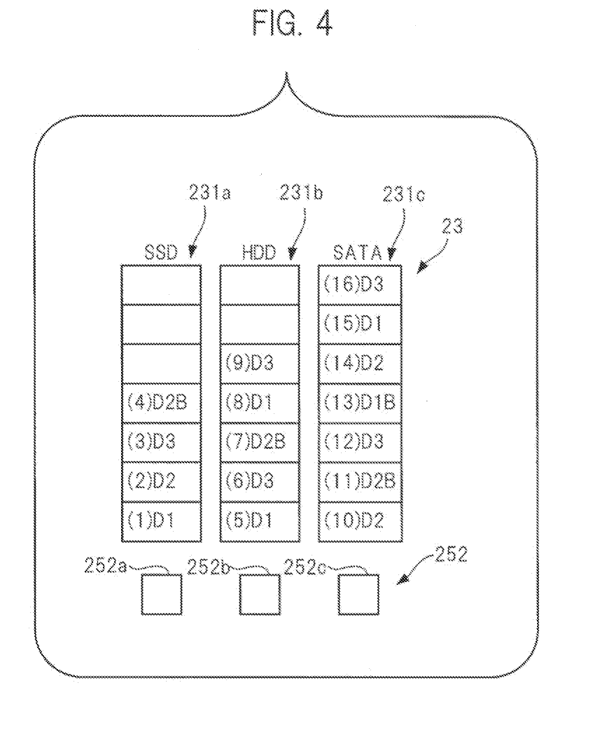

FIG. 4 is a diagram that illustrates the cache memory and the flag storage section.

The cache memory 23 has plural (here, three) storage areas 231a, 231b and 231c resulting from the division according to the types (SSD, HDD, and SATA) of disk.

Further, the flag storage section 252 has three flag areas 252a, 252b and 252c corresponding to the respective three storage areas 231a, 231b and 231c of the cache memory 23. In each of these three flag areas 252a, 252b and 252c, there is stored the empty flag that is on at the time of the empty state in which there is no data in the corresponding one of the storage areas 231a, 231b and 231c, and that is off at the time when the write data is present in the corresponding storage area.

Here, assume the write data illustrated in FIG. 4 is already stored in the cache memory 23. In other words, four pieces of write data, namely (1)D1, (2)D2, (3)D3 and (4)D2B, are aligned in the storage area 231a in which the write data to be written to the SSD is stored. Here, a column of write data for each of the storage areas 231a, 231b and 231c is referred to as a “queue”.

Here, (1), (2), . . . , (4) represent the priority order of being taken from the cache memory 23, in this storage area 231a. (1) is given the highest priority, and (2), (3) and (4) are given lower priorities in this order. Further, D1, D2 and D3 each represent the enclosure that houses the disk (here, SSD) to which the write data is to be written. Here, the enclosures each housing the disk (SSD, HDD, SATA) are three enclosures D1, D2 and D3, for example. Further, “B” of (4)D2B indicates that the disk (here, SSD) to which the write data is to be written is currently in a busy state. Information indicating whether or not the disk is in the busy state is not written in the cache memory 23, but here, this information is indicated with “B” for easy understanding. Whether or not a certain disk is in the busy state is checked by referring to the flow-rate management table 251 illustrated in FIG. 2 and FIG. 3, and when 100% is written in the flow-rate management table 251, it is recognized that the disk is in the busy state.

Here, in any of the storage areas 231a, 231b and 231c, among the pieces of write data stored in one storage area, the pieces of write data located in lower positions are given higher priorities for being taken, and the illustration appear to be based on FIFO. This merely illustrates the priorities, and the pieces of write data are not necessarily stored in the storage area in this order in reality. In other words, here, the order of taking the write data stored in the storage area 231a may be based on a mode other than the FIFO such as LRU or the like, and FIG. 4 illustrates the priority order for taking in the adopted mode. However, for easy understanding, the description will be continued assuming that the FIFO is adopted.

Further, in the storage area 231b for HDD of the cache memory 23, pieces of write data (5)D1, (6)D3, (7)D2B, (8)D1, and (9)D3 are illustrated. (5) to (9) represent the order of precedence for taking the write data from the cache memory 23, in this storage area 231b. (5) to (9) are not indicated as (1) to (5) to be distinguished from (1) to (4) of the storage area 231a, and do not mean that (5) to (9) are given lower priorities than (1) to (4).

This also applies to the storage area 231c of the cache memory 23. Here, write data of (10)D2 to (16)D3 are stored.

In the state illustrated in FIG. 4, the write data is stored in any of the three storage areas 231a, 231b and 231c of the cache memory 23 and thus, all of the three flag areas 252a, 252b and 252c of the flag storage section 252 are in a flag-off state.

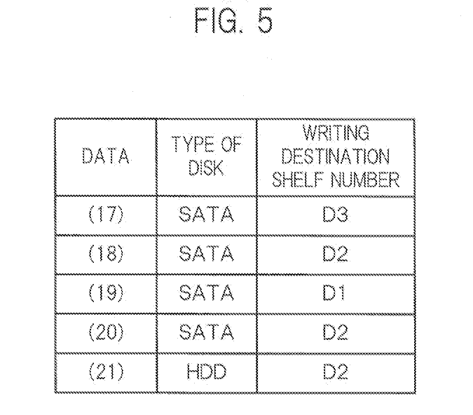

FIG. 5 is a diagram that illustrates a list of pieces of write data newly transmitted from the host.

Suppose when the write data illustrated in FIG. 4 is stored in the cache memory 23, the write data to be written to the disk of each type in each enclosure illustrated here is newly transmitted from the host 90, in order from (17) to (21) illustrated in this FIG. 5.

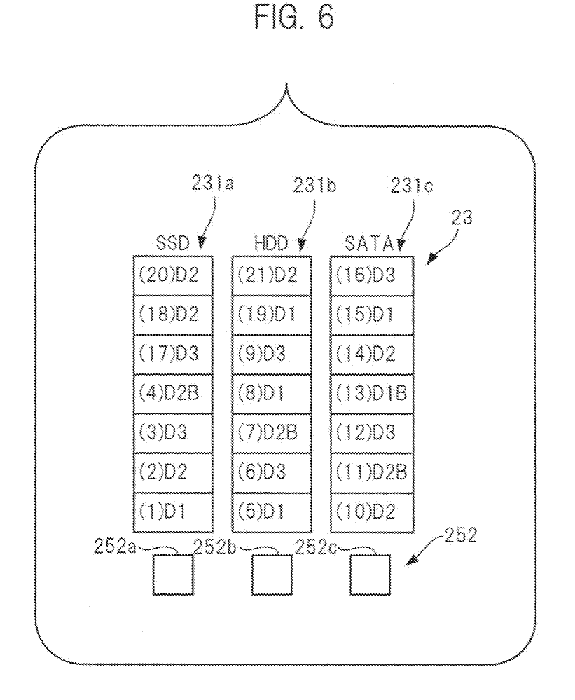

FIG. 6 is a diagram that illustrates the cache memory in a state in which the write data illustrated in FIG. 5 is stored in the cache memory illustrated in FIG. 4.

Here, there is established the following rule to be followed at the time when the storage section 22 stores the write data to the cache memory.

(1) When there is empty space in the cache memory 23's own area, the storage section 22 stores the write data received by the communication section 21 in the empty space. Here, the “own area” refers to: the storage area 231a when the write data is to be written to the SSD; the storage area 231b when the write data is to be written to the HDD; and the storage area 231c when the write data is to be written to the SATA.

(2) At the time of storing the write data received by the communication section 21 in the cache memory 23, the storage section 22 acts as follows when the storage area corresponding to the type of the disk to which the write data is to be written is full. That is, when there is a storage area corresponding to the type with the writing speed higher than that type and there is empty space in the storage area corresponding to the higher-speed type, the write data is stored in the storage area corresponding to that higher-speed type. Here, the storage area corresponding to this higher-speed type is referred to as a “loaded area”. However, in the present embodiment, there is an upper limit to the number of acceptances for storing the write data of other types of disk which is possible to be stored in the storage area corresponding to such a higher-speed type, and this upper limit is defined as being three or less. This number of acceptances is set, based on statistics and the like about the storage rate of the write data to the storage area, to be a level in which a possibility of occurrence of a trouble is low even if the write data for other types of disk is accepted.

(3) Further, when there are two or more storage areas corresponding to the high-speed type and these storage areas have empty spaces, the write data is stored in the storage area whose empty space is wider. When the sizes of the empty spaces in the two or more storage areas are the same, the write data is stored in the storage area corresponding to the disk of the type whose writing speed is higher.

In the present embodiment, this rule applies to a case in which the write data to be written to the SATA is received from the host 90, the storage area 231c corresponding to the SATA is full, and there is empty space in the two storage areas 231a and 231b corresponding to the HDD and the SSD, respectively.

(4) When there is no empty space in the own area and there is no loaded area, as well as when neither the own area nor the loaded area has empty space even if the loaded area is present, the storage section 22 causes the communication section 21 to inform the host 90 of the fact that there is no available area.

(5) At the time of storing the write data received by the communication section 21 in the storage area corresponding to the type of the disk to which the write data is to be written, of the cache memory 23, when the storage area is in the empty state in which no write data is stored at least immediately before the current writing, the storage section 22 updates the empty flag corresponding to that storage area, of the flag storage section 252, to the off state representing the presence of the write data in the storage area.

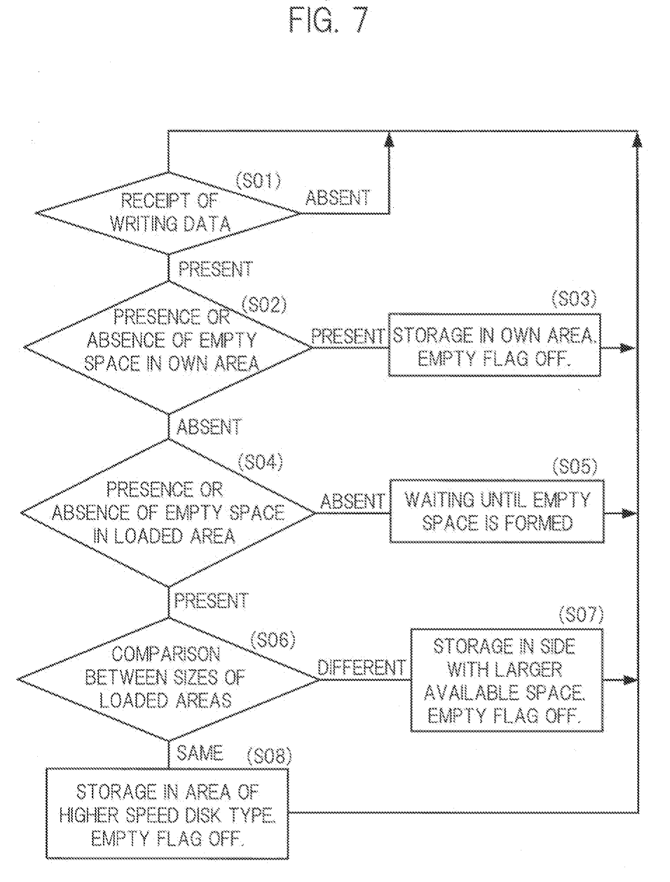

FIG. 7 is a flow chart that illustrates the processing of the storage section that follows the above-described rule.

When the write data is received by the communication section 21 (step S01), it is determined whether there is empty space in the own area corresponding to the type of the disk to which the write data is to be written, of the cache memory (step S02). When there is empty space in the own area, the write data is stored in the own area, and the empty flag corresponding to the own area is turned off (step S03).

When the own area is full and has no empty space, the presence or absence of empty space in the loaded area corresponding to the disk type whose writing speed is higher than the own area is checked (step S04). When the loaded area also has no empty space, the processing waits until empty space is formed (step S05). In other words, here, the communication section 21 is caused to inform the host 90 of the fact that the cache memory 23 is full, and the processing illustrated in FIG. 7 is performed again at the time when the write data is transmitted from the host 90 again at an appropriate time.

When there is empty space in the loaded area, the write data is stored in the loaded area. However, in the present embodiment, when the storage area 231c corresponding to the SATA is assumed to be the own area, there are two or more (here, two) loaded areas. Thus, when a destination to which the write data received this time is to be written is the SATA, and the storage area 231c corresponding to the SATA is full, the respective sizes of the two or more leaded areas are compared, and when there is a difference between the sizes, the write data is stored in the loaded area with wider empty space (step S07). At the time, the empty flag corresponding to the loaded area where the data is stored becomes off. When there is no difference between the sizes of the loaded areas, the write data is stored in the loaded area corresponding to the disk type capable of higher-speed writing, of these loaded areas (step S08). At the time, the empty flag corresponding to the loaded area where the write data is stored becomes off.

Incidentally, in the processing illustrated in this FIG. 7, every time the write data is stored in the storage area, the empty flag corresponding to the storage area is turned off regardless of whether other write data is already stored in that storage area. However, the empty flag is turned off when the write data is initially stored immediately after the storage area corresponding to the empty flag is in the empty state. Therefore, the on-off of the empty flag may be judged to determine whether this is the case (the empty flag is on), and the empty flag may be turned off only in that case.

Here, while the cache memory 23 is in the state illustrated in FIG. 4, when the write data illustrated in FIG. 5 is received by the communication section 21, the cache memory 23 enters the state illustrated in FIG. 6, which will be described as follows.

The write data (17) illustrated in FIG. 5 is the data to be written to the SATA in the enclosure D3, but as illustrated in FIG. 4, the storage area 231c that is the SATA's own area is already in a full state. Thus, the empty space of the storage area 231a corresponding to the SSD and the storage area 231b corresponding to the HDD are checked. There is empty space in both of the storage areas 231a and 231b, and the empty space of the storage area 231a of the SSD is wider. Thus, the write data (17) is stored in the storage area 231a of the SSD.

The next write data (18) is the data to be written to the SATA in the enclosure D2. The storage area 231c of the SATA is already full. In the storage area 231a of the SSD, the write data (17)D3 is stored after the state illustrated in FIG. 4. Therefore, at this stage, the storage area 231a of the SSD and the storage area 231b of the HDD have the empty space of the same size. In this case, the write data (18) also is stored in the empty space of the SSD whose data-writing speed is higher.

The next write data (19) also is the data to be written to the SATA, but the storage area 231c of the SATA is full, and the storage area 231b of the HDD has the empty space that is wider than the storage area of the SSD at this stage. Thus, the write data (19) is stored in the storage area 231b of the HDD.

Further, the next write data (20) also is for the SATA. The storage area 231c of the SATA is full, and both of the storage area 231a of the SSD and the storage area 231b of the HDD each have one empty space. Thus, the write data (20) is stored in the storage area 231a of the SSD whose data-writing speed is higher.

Furthermore, the next write data (21) is for the HDD. There is empty space in the storage area 231b that is the HDD's own area and thus, the write data (21) is stored in the storage area 231b of the HDD.

As a result, the cache memory 23 is in the state illustrated in FIG. 6.

Next, the writing section that takes out the write data from the cache memory and writes the taken data to the disk will be described.

The writing section 24 follows a rule described below.

(1) The writing section 24 takes out the write data from those cyclically selected from among the three storage areas 231a, 231b and 231c in the cache memory 23 and writes the taken data to the disk.

Here, in increasing order of data-writing speed, write data is taken one by one in order of the storage area 231a of the SSD→the storage area 231b of the HDD→the storage area 231c of the SATA→the storage area 231a of the SDD→ . . . , and the taken write data is written to each disk.

(2) However, when taking the write data from the cache memory 23, the writing section 24 refers to the flow-rate management table 251 (see FIG. 3), and determines whether the disk 31, to which the write data that is currently about to be taken is to be written, is in the busy state. When the disk 31 that is the writing destination is in the busy state, the writing section 24 lowers the priority level for reading of the write data that is currently about to be taken, among pieces of write data stored in the storage area where that write data is stored. Specifically, in the present embodiment, this propriety level for reading is made to be the lowest among the pieces of write data stored in that storage area. Subsequently, the writing section 24 reads out the write data given the next highest priority among the pieces of write data stored in that storage area.

(3) As described above, this RAID apparatus 10 includes the plural enclosures 30 in each of which the disks 31 are aligned, and the amount of communication between the controller 20 and the disks 31 is restricted for each of the enclosures 30.

Thus, when taking the write data from the cache memory 23, the writing section 24 checks the difference between the enclosure 30 in which the disks 31 to which first write data that is to be taken or has been taken this time are aligned and the enclosure 30 in which the disks 31 to which second write data that is to be taken next time are aligned. Subsequently, when both of the enclosures 30 are identical, the writing section 24 does not take out the second write data at the time of the next taking. At this moment, the writing section 24 reads out third write data, which is given the highest priority level for reading next to the second write data, among the pieces of write data stored in the same storage area as that of the second write data.

(4) Further, after reading the write data from the storage area in the full state, the writing section 24 determines whether the write data to be written to the disk of the type corresponding to the storage area that has been in the full state is stored in the storage area other than the storage area that has been in the full state. Subsequently, when the write data is stored in the other storage area, the writing section 24 moves the write data stored in the other storage area to the storage area that has been in the full state.

(5) Furthermore, when taking the write data from the cache memory 23, the writing section 24 determines whether the current taking of the write data causes the storage area, which is targeted for the current taking of that write data, of the cache memory 23, to shift to the empty state in which no write data is stored. Subsequently, in a case in which the storage area is going to shift to the empty state, the writing section 24 updates the empty flag corresponding to that storage area to the ON state representing the absence of the write data in the storage area. Further, when taking the write data from the cache memory 23, the writing section 24 performs reading processing for the storage area in which the empty flag of the flag storage section 252 is in the OFF state representing the presence of the write data. On the other hand, for the area in which the empty flag is in the ON state representing the absence of the write data, the reading processing is not performed.

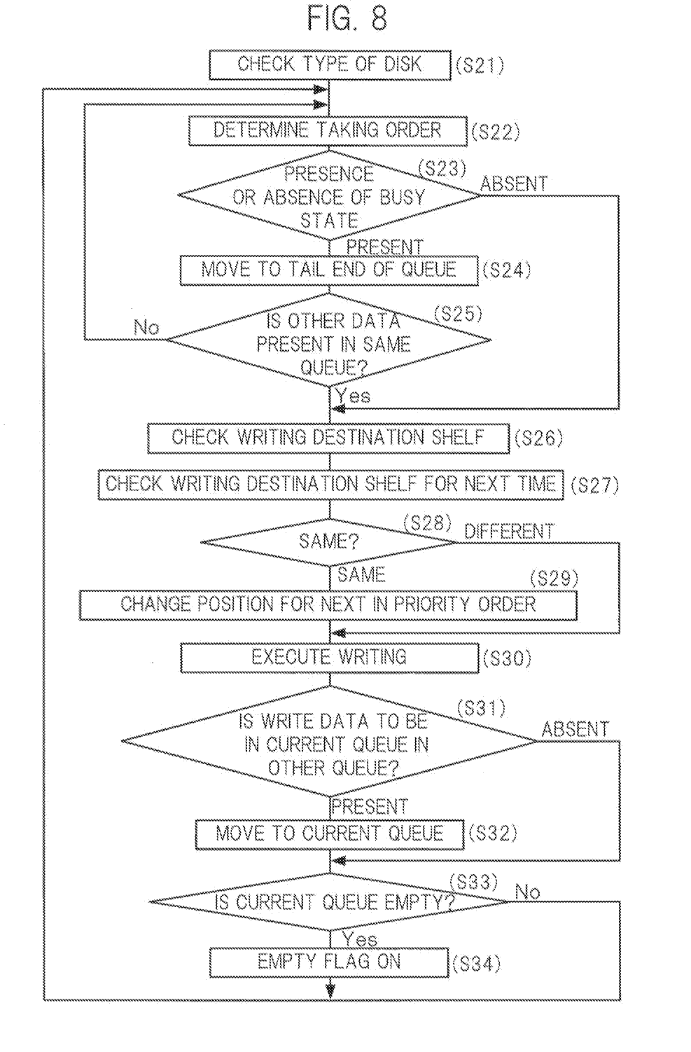

FIG. 8 is a flow chart that illustrates the processing of the writing section.

Here, at first, the type of each disk aligned in each of the enclosures 30 is checked (step S21). This checking is performed whenever a change of the storage state of the disk in the RAID apparatus 10 occurs or whenever there is a possibility that the change has occurred.

Subsequently, the state of the storage to the cache memory 23 of the write data is checked, and the order of writing to the disk 31 is determined (step S22). Here, the write data to be read out this time and the write data to be read out next time are determined.

Next, for the first write data in the order of writing determined this time, it is determined whether the disk to which the write data is to be written is in the busy state. This determination is performed by referring to the flow-rate management table 251 (FIG. 3) as described above. When the disk to which the write data is to be written this time is in the busy state, this write data is moved to the tail end of the queue of the pieces of write data aligned in the storage area. In other words, the priority level for reading of that write data is lowered to the lowest among the pieces of write data aligned in that queue.

Subsequently, when there is other write data in the same queue, the write data given the next priority is taken. When there is no other write data in the same queue, the flow returns to step S22 and the order of taking the write data is determined again.

In step S26, the enclosure 30 loaded with the disk 31, to which the write data to be taken this time from the cache memory 23 is to be written, is checked. And then in step S27, the enclosure 30 loaded with the disk 31, to which the write data to be taken next time from the cache memory 23 is to be written, is checked. In step S28, it is determined whether those enclosures 30 are identical, and when those enclosures 30 are identical, the priority order in the queue for the next time is changed (step S29). Specifically, the first write data (the head in the order of precedence) in the queue for the next time and the second write data (the second in the order of precedence) in the same queue are interchanged in the order of alignment in the queue (in the order of precedence).

In step S30, the write data targeted for the taking this time is taken from the cache memory 23, and the taken write data is written to the disk 31.

Subsequently, it is checked whether the write data to be aligned in the queue from which the write data has been taken this time is in other queue, namely whether this write data is in other storage area (step S31). This is because even the write data to be originally aligned in this queue happens to be stored in other storage area (i.e. aligned in other queue), when the storage area where this queue is arranged is full.

When the write data to be aligned in the current queue is in other queue, the write data is moved to the current queue (step S32). However, there is a case in which even when the storage area where the write data aligned in the current queue is stored becomes full, the write data aligned in the current queue is in other queue. At the time, the remaining write data aligned in this other queue is taken, while being kept arranged in this other queue.

Further, in step S33, it is checked whether the queue from which the write data is taken this time has become empty (step S33), and when the queue has become empty, the empty flag corresponding to that storage area is changed to ON (step S34).

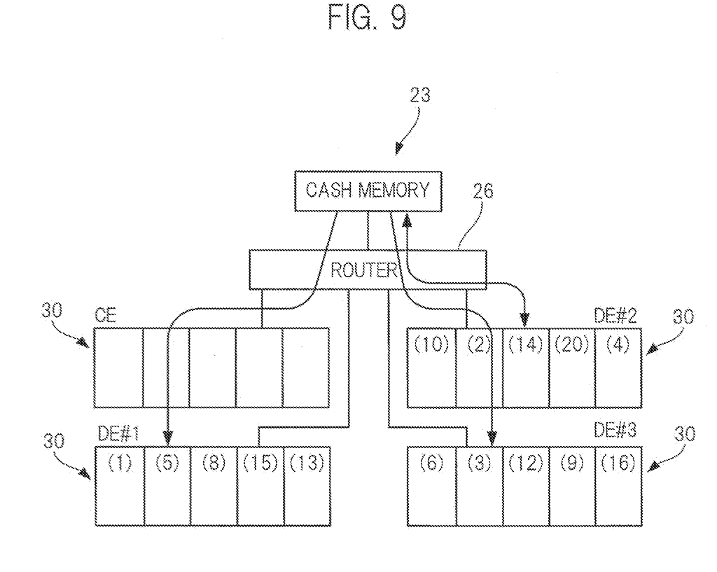

FIG. 9 illustrates a data flow between the cache memory and each enclosure. Here, there are two types of enclosure 30, namely DE (Device Enclosure) and CE (Controller Enclosure), and there are three DEs, namely DE#1, DE#2 and DE#3. Each DE is loaded with plural disks, as previously described. In the CE, physically, the controller 20 (see FIG. 1) is disposed. Here, no disk is assumed to be provided in the CE. Codes such as (1), (2), . . . and so on provided with DE#1, DE#2 and DE#3 agree with the codes (1), (2), . . . and so on of the respective pieces of write data illustrated FIG. 6. In other words, this FIG. 9 illustrates the disk to which the write data of a certain code is to be written is disposed in the enclosure indicated with the same code. The write data stored in the cache memory 23 is taken from the cache memory 23, sent via a router 26 to the enclosure 30 in which the disk to which the taken write data is to be written is disposed, and written to that disk of the enclosure 30.

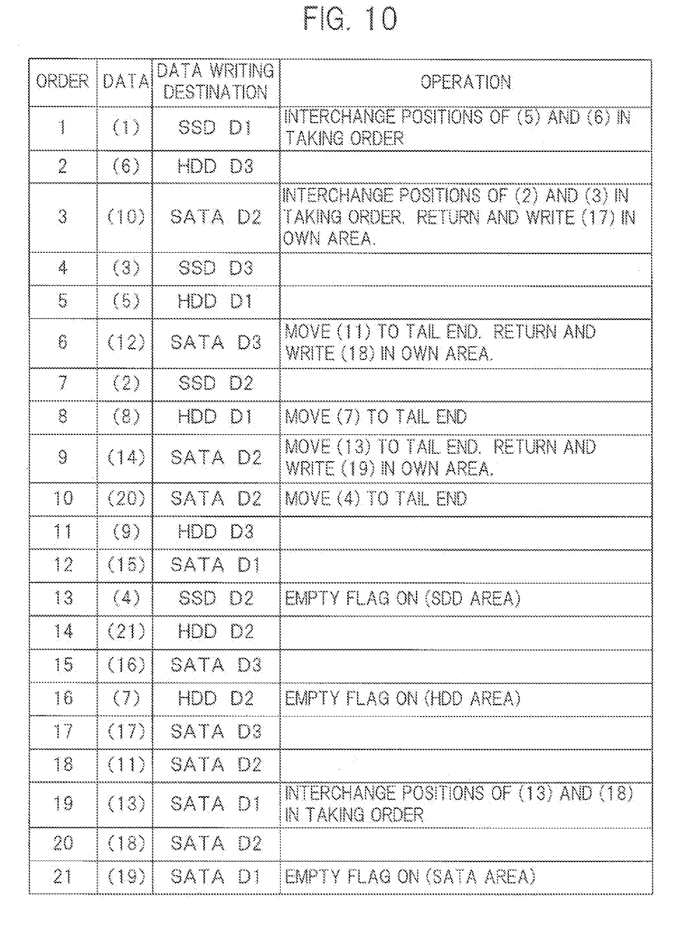

FIG. 10 is a diagram that illustrates the order of taking the write data from the cache memory in the state illustrated in FIG. 6.

1.First, the write data (1) illustrated in FIG. 6 is taken, and written to the SSD disposed in the enclosure DE#1. At the time, the difference between the enclosure that is the writing destination of the write data (1) and the enclosure of the writing destination of the write data (5) to be taken next is checked. Here, both of these pieces of write data are for the same enclosure DE#1 and thus, the positions in the order of being taken from the cache memory 23 of the write data (5) and the write data (6) are interchanged.

2. Thus, the write data (6) is taken next, and the taken write data is written to the HDD arranged in the enclosure DE#3.

3. Next, the write data (10) is taken and written to the SATA disposed in the enclosure DE#2. The write data (10) and the write data (2) are written to the same enclosure DE#2 and thus, the positions in the order of being of the write data (2) and the write data (3) are interchanged. Further, empty space is produced in the storage area 231c of the SATA by the taking of (10)D2 and thus, (17)D3 that is the data to be written to the SATA is moved to the storage area 231c of the SATA and arranged in the queue of the SATA.

4. Next, the write data (3) is taken and written to the SSD disposed in the enclosure DE#3.

5. Subsequently, the write data (5) interchanged with (6) is taken, and written to the HDD disposed in the enclosure DE#1.

6. The next turn will be of the write data (11), but the disk to which this write data (11) is to be written is currently in the busy state. For this reason, the position of this write data (11) is placed at the tail end (behind D3(16)) of the queue of the SATA. Subsequently, the write data (12) is taken instead of the write data (11), and written to the SATA of the enclosure DE#3. Further, the write data (18) to be written to the SATA is returned and written to the storage area 231c of the SATA.

7. (2)D2 is taken and written to the SSD of the enclosure DE#2.

8. D2B is in the busy state and thus, taking of this write data is placed at the tail end of the queue, and instead of the write data (7), the write data (8) is read out and written to the HDD of the enclosure DE#1.

9. Further, (13)D2B is placed to the tail end of the queue, and (14)D2 is taken and written to the SATA of the enclosure DE#2. Furthermore, (19)D1 is returned and written to the own area (the storage area 231c of the SATA).

Afterwards, in a similar fashion, the write data is taken from the cache memory 23 according to the procedure in FIG. 8, and written to each of the disks 31.

Here, for example, in “13” of FIG. 10, after the write data (4)D2 is taken, the storage area 231a of the SSD becomes empty. For this reason, here, the flag area 252a corresponding to the storage area 231a of the SSD is set to the ON state representing the storage area 231a being empty.

This also applies to “16” and “21” in FIG. 10.

According to the above-described embodiment, the writing to the SSD is caused to be kept waiting at maximum during the writing of one piece of write data to the HDD and the writing of one piece of write data to the SATA, but does not have to be kept waiting longer than such a waiting time. Therefore, the “sinking” in the performance of the SSD is suppressed.

Also, as for the HDD and the SATA, the writing turn comes reliably and thus, the writing is performed without an occurrence of an extreme delay. In this RAID apparatus 10, the performance as a whole is improved in this way.

Incidentally, here, the description has been provided by using the RAID apparatus, but the present application is not limited to the apparatus called the RAID apparatus, and may be widely applied to storage systems where two or more separate storage devices are housed.

According to the storage system and the data writing method of the present application, pieces of write data are sequentially taken from the storage areas sequentially selected from among the storage areas on the cache memory, and written to the individual storage devices. For this reason, a degradation (sinking) in performance of the individual storage devices whose data-writing speed is high is prevented, and a significant delay in writing to the individual storage devices whose data-writing speed is low also is prevented.

All examples and conditional language recited herein are intended for pedagogical purposes to aid the reader in understanding the invention and the concepts contributed by the inventor to furthering the art, and are to be construed as being without limitation to such specifically recited examples and states, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage system connected to an external device, comprising:
plural types of individual storage devices storing data and varying in data-writing speed;
a cash memory that stores the write data to be written to the individual storage device;
a storage section that stores the write data received from the external device and to be written to the individual storage device, in a storage area according to a type of the individual storage device to which the write data is to be written, among a plurality of storage areas divided according to respective types of the individual storage devices, of the cash memory; and
a writing section that sequentially takes the write data from the storage area sequentially selected from among the plurality of storage areas in the cash memory and writes the taken data to the individual storage device.

2. The storage system according to claim 1, further comprising:
a flag storage section that stores, corresponding to each of the plurality of storage areas of the cash memory, a flag indicating whether the write data to be written to the individual storage device is stored in the storage area, wherein
in storing the received write data in the storage area corresponding to the type of the individual storage device to which the write data is to be written, of the cash memory, when the storage area is in an empty state in which no write data is stored at least immediately before writing of this time, the storage section updates the flag corresponding to the storage area, of the flag storage section, to a state indicating that the write data is present in the storage area, and
in taking the write data from the cash memory, when taking the write data this time causes the storage area targeted for taking of the write data this time to shift to the empty state in which no write data is stored, of the cash memory, the writing section updates the flag corresponding to the storage area, of the flag storage section, to a state indicating that the write data is absent in the storage area, and in taking the write data from the cash memory, the writing section performs reading processing for the storage area for which the flag of the flag storage section is in the state indicating that the write data is present.

3. The storage system according to claim 1, further comprising:
an update section that updates a state management table indicating whether each of the individual storage devices is in a busy state in which a new access is disabled, wherein
the writing section refers to the state management table when taking the write data from the cash memory in reading the write data from the cache memory, and when the individual storage device to which the write data to be taken this time is to be written is in the busy state, the writing section lowers a priority level for reading the write data to be taken this time among the write data stored in the storage area in which the write data is stored, and reads the write data of a next priority for reading among the write data stored in the storage area.

4. The storage system according to claim 1, further comprising:
a plurality of enclosures in each of which the individual storage devices are aligned, wherein
an amount of communication between the cash memory and the individual storage devices is restricted for each of the enclosures, and
when taking the write data from the cash memory, the writing section checks a difference between the enclosure in which the individual storage devices to which first write data to be taken this time is to be written are arranged and the enclosure in which the individual storage devices to which second write data to be taken next time is to be written are arranged, and when the both enclosures are identical, the writing section takes, at the time of next taking, instead of taking the second write data, third write data of a higher priority next to the second write data among the write data stored in the same storage area as the second write data.

5. The storage system according to claim 1, wherein in storing the received write data in the cash memory, when the storage area corresponding to the type of the individual storage device to which the write data is to be written is full, and the storage area corresponding to the type of the individual storage device whose writing speed is higher than the former type and also, there is empty space in the storage area corresponding to the higher type, the storage section stores the write data in the storage area of the higher type.

6. The storage system according to claim 1, wherein after reading the write data from a first storage area in a full state, of the cash memory, when the write data to be written to the individual storage device of the type corresponding to the first storage area that has been in the full state is stored in a second storage area other than the first storage area, the writing section moves the write data, which is to be written to the individual storage device of the type corresponding to the first storage area and is stored in the second storage area, to the first storage area.

7. A data writing method, wherein
the data writing method is used in a storage system that is connected to an external device, receives write data from the external device and writes the write data to plural types of individual storage devices storing data and varying in data-writing speed, and upon receipt of a data-reading command from the external device, reads the data from the individual storage device of the plural types of individual storage devices and transmits the read data to the external device,
the storage system includes a cash memory that stores the write data to be written to the individual storage device, until the write data is written to the individual storage device, and
the data writing method comprises:
in storing the write data from the external device and to be written to the individual storage device, storing the write data to a storage area corresponding to a type of the individual storage device to which the write data is to be written, among a plurality of storage areas divided according to respective types of the individual storage devices, of the cash memory; and
in taking the write data for the individual storage device from the cash memory and writing the taken write data to the individual storage device, taking sequentially the write data from the storage area sequentially selected from among the plurality of storage areas on the cash memory, and writing the taken data to the individual storage device.
